(19) United States
(12) Patent Application Publication
(10) Pub. No.: US 2016/0051892 A1
(43) Pub. Date: Feb. 25, 2016

(54) METHOD AND DEVICE FOR DISPLAYING GAME OBJECTS

(71) Applicant: NetEase (Hangzhou) Network Co., Ltd., Hangzhou (CN)

(72) Inventors: Fei Gao, Hangzhou (CN); Ninghe Pan, Hangzhou (CN); Jingran Meng, Hangzhou (CN)

(21) Appl. No.: 14/831,878

(22) Filed: Aug. 21, 2015

(30) Foreign Application Priority Data
Aug. 25, 2014 (CN) 201410421695.0

(51) Int. Cl. A63F 13/25; A63F 13/21

(52) U.S. Cl. CPC A63F 13/25; A63F 13/21

(57) ABSTRACT

Embodiments of the present invention provide a method and device for displaying game objects in a touch screen of limited size. The method at least comprises: setting a first display area along a first vertical edge of the display screen so as to display at least a first game object in the first display area, said first display area being a first functional zone of the game; and outside of the first display area, setting a second display area along the horizontal direction of the display screen so as to display at least a second game object in the second display area, said second display area being a second functional zone of the game.

### CROSS-REFERENCE TO RELATED APPLICATION

This application is related to, and claims priority to Chinese Patent Application No. 201410421695.0 filed on Aug. 25, 2014, which is incorporated by reference herein in its entirety.

### TECHNICAL FIELD

Embodiments of the present invention relate to the field of display, and more particularly, to a method and device for displaying game objects.

### BACKGROUND OF THE INVENTION

This section is intended to provide the background or context for the embodiments of the present invention as recited in the claims. The fact that following descriptions being included in this section itself cannot be used as an admission of prior art.

At present, there is an increasing number of game applications emerging on mobile terminals. During the running of a game application, a mobile terminal displays various game objects according to a certain layout, so as to render a game scene and provide a game operation interface to a user. Mostly, the display screen provided on the mobile terminal is of a rectangular shape with unequal length and width. Further, it is realized that the game screen provides a larger space to display more game objects and facilitate faster operations by both hands when the mobile terminal is held in the horizontal direction. Accordingly, many game applications are designed to display game objects horizontally in a mobile terminal's screen. In other words, the horizontal side of a display area provided by the display screen is longer than the vertical side in length.

In some game applications, a plurality of different display areas are set on a horizontally displaying display screen, and game objects are placed and displayed in respective display areas. For example, in certain battle game applications, there may be at least three different display areas on the horizontally displaying display screen, and in particular, resource objects of an operating user, resource objects of an opponent user, and battle objects from both users participating in the battle on the field may be displayed in those three display areas, respectively.

In the prior art, display areas on a horizontally displaying display screen are usually set along the horizontal direction and separate from one another in the vertical direction. Specifically, a plurality of display areas might be provided from top to bottom on the horizontally displaying display screen, and boundary lines separating the display areas are along the horizontal direction. For example, in an example of display areas in the prior art as shown in FIG. 1, regarding the aforesaid battle game application, there are three display areas provided from top to bottom on a horizontally displaying display screen. In particular, resource objects of an operating user are placed and displayed in an “operating user resource area” which is an area located at the lower edge of the display screen; resource objects of an opponent user are placed and displayed in an “opponent user resource area” which is an area located at the upper edge of the display screen; battle objects from both users participating in the battle on the field are placed in a “battle area” which is an area located in the middle of the display screen and sandwiched between the “operating user resource area” and the “opponent user resource area”.

### SUMMARY OF THE INVENTION

In a game application, some game objects have specific content such as numeric parameters and text description thereon. During the running of the game, a user needs to check the content on the game objects in order to be aware of the progress of the game and to determine what operations are to be performed. For this purpose, when the game objects are being displayed, it is desired that the specific content on the game objects can be clearly presented to the user. However, as previously mentioned, the display screen of a mobile terminal is typically shorter in the vertical direction when said mobile terminal being held by both hands horizontally, and display areas are only separated from one another in the vertical direction. Thus, when more than one display areas are set on the horizontally displaying display screen as taught in the prior art, the vertical length of each display area is allocated only a portion of the entire vertical length of the display screen, resulting in the vertical length of each display area being excessively short. Hence, placing game objects with specific content in the display areas would cause the displayed game objects being too small due to limitation of the vertical lengths of the display areas, resulting in the specific content on the game objects being difficult to be recognized by the user and not being able to be clearly displayed.

Therefore, in the prior art, the excessively short vertical length of the display areas limit the sizes of the displayed game objects, thereby causing the specific content on the game objects not being able to be clearly displayed, which is very annoying.

For this reason, a great need exists for an improved method and device for displaying game objects to avoid the displayed game objects being too small and help user recognize the specific content on the game objects, so as to ensure that the specific content on the game objects is clearly displayed.

In this context, the embodiments of the present invention aim to provide a method and device for displaying game objects.

In a first aspect of the embodiments of the invention, there is provided a display method used in a handheld device with a touch-interaction display screen, said display screen being capable of horizontally displaying a game scene, comprising: setting a first display area along a first vertical edge of the display screen so as to display at least a first game object in the first display area, said first display area being a first functional zone of the game; and outside of the first display area, setting a second display area along the horizontal direction of the display screen so as to display at least a second game object in the second display area, said second display area being a second functional zone of the game; wherein, a first vertical boundary of the first display area is the first vertical edge of the display screen, a first vertical boundary of the second display area is a second vertical edge of the display screen, and a second vertical boundary of the second display area at least partially overlaps with a second vertical boundary of the first display area.

In a second aspect of the embodiments of the invention, there is provided a handheld device with a touch-interaction display, said display screen being capable of horizontally displaying a game scene, said device comprising: a first setting portion used for setting a first display area along a first vertical edge of the display screen so as to display at least a first game object in the first display area, said first display area being a first functional zone of the game; and a second setting portion used for, outside of the first display area, setting a second display area along the horizontal direction of the display screen so as to display at least a second game object in the second display area, said second display area being a second functional zone of the game; wherein, a first vertical boundary of the first display area is the first vertical edge of the display screen, a first vertical boundary of the second display area is a second vertical edge of the display screen, and a second vertical boundary of the second display area at least partially overlaps with a second vertical boundary of the first display area.

With the method and device for displaying game objects according to the embodiments of the invention, on a horizontally displaying display screen, a first display area for displaying first game objects may be set along a vertical edge of the display screen, and outside of the first display area, a second display area for displaying second game objects may be set along the horizontal direction. Specifically, a first vertical boundary of the first display area is a first vertical edge of the display screen, a first vertical boundary of the second display area is a second vertical edge of the display screen, and the second vertical boundary of the second display area at least partially overlaps with a second vertical boundary of the first display area. Therefore, as compared with arrangement of display areas in the prior art, in the embodiments of the present invention, the vertical length of the first display area is extended to the vertical length of the entire display screen, and the first display area no longer shares the vertical length of the display screen with the second display area so that the vertical lengths of the first display area and the second display area are both extended. As such, the first game objects and the second game objects displayed in this way would not be excessively small. It is easier for a user to recognize specific content on the game objects, thereby achieving clearer display of the specific content on the game objects and a better experience for the user.

### BRIEF DESCRIPTION OF THE DRAWINGS

The above and other objectives, features and advantages of exemplary embodiments of the invention will become more readily understandable by reading the following detailed description with reference to the accompanying drawings. A number of embodiments of the invention are shown in an exemplary and unrestrictive manner in the drawings, of which:

FIG. 1 schematically illustrates a schematic diagram of an example of display areas for displaying game objects in the prior art;

FIG. 2 schematically illustrates a framework diagram of an exemplary application scenario in accordance with the embodiments of the invention;

FIG. 3 schematically illustrates a flow diagram of an example of the method for displaying game objects of the invention;

FIG. 4a schematically illustrates a schematic diagram of an example of display area setting of an example of the invention;

FIG. 4b schematically illustrates a schematic diagram of another example of display area setting of an example of the invention;

FIG. 4c schematically illustrates a schematic diagram of another example of display area setting of an example of the invention;

FIG. 4d schematically illustrates a schematic diagram of another example of display area setting of an example of the invention;

FIG. 4e schematically illustrates a schematic diagram of another example of display area setting of an example of the invention;

FIG. 5a schematically illustrates a schematic diagram of an example of sliding first game objects in a first display area of an example of the invention;

FIG. 5b schematically illustrates a schematic diagram of another example of sliding first game objects in a first display area of an example of the invention;

FIG. 5c schematically illustrates a schematic diagram of another example of sliding first game objects in a first display area of an example of the invention;

FIG. 6 schematically illustrates a structure diagram of an example of the device for displaying game objects of the invention;

FIG. 7 schematically illustrates a structure diagram of an embodiment of a slide displaying module 603 of an example of the invention;

FIG. 8 schematically illustrates a structure diagram of an embodiment of a movement displaying module 604 of an example of the invention.

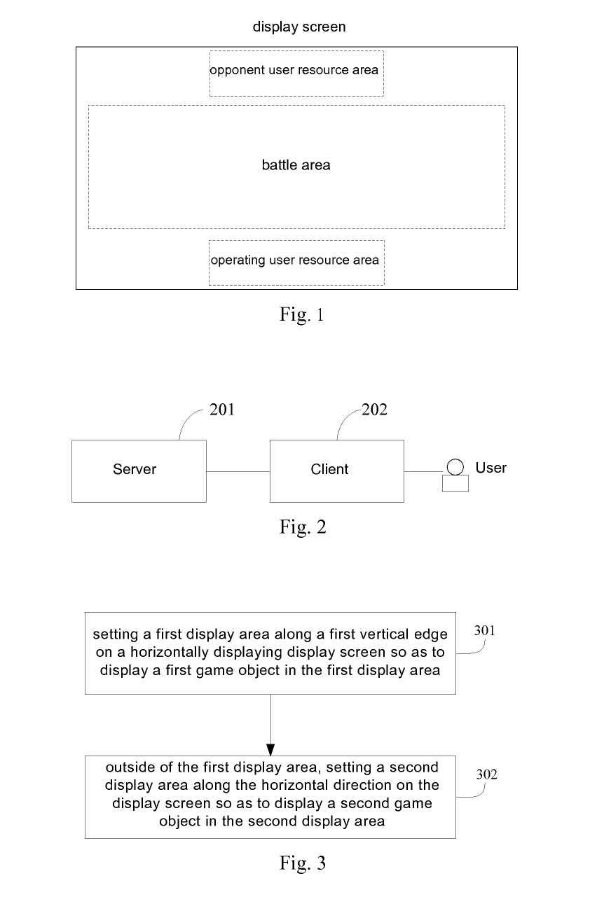

In the drawings, identical or corresponding numerals denote identical or corresponding parts.

### DETAILED DESCRIPTION OF THE INVENTION

The principles and spirit of the present invention will be described below with reference to a number of exemplary embodiments. It should be understood that those embodiments are given merely for those skilled in the art to better understand and thus implement the invention, and do not limit the scope of the invention in any way. On the contrary, those embodiments are provided to make the disclosure more thorough and complete, so that the scope of the disclosure may be completely conveyed to those skilled in the art.

It is known to those skilled in the art that the embodiments of the invention may be implemented as a system, device, apparatus, method or computer program product. Thus, the present disclosure may be specifically implemented in the form of complete hardware, complete software (including firmware, resident software, microcode, etc.), or combinations of hardware and software.

A method and device for displaying game objects are proposed in accordance with the embodiments of the invention.

It is to be understood that, in this context, the term “game object” represents an object in a game application that is to be presented to a user. For example, in battle games, a game object may comprise a resource object provided to the user for selection and use. Alternatively, the game object may also comprise a battle object participating in the battle. Furthermore, in a trade card game (TCG), the resource object comprised in the game object may be a card, and the battle object comprised in the game object may be a battle character, such as a creature, generated after the use of the card. In addition, the term “display area” represents an area set on a display screen and used to present a certain specific game object or certain specific types of game objects. For example, it might be a display area for displaying resource objects or a display area for displaying battle objects. Moreover, any number of elements in the drawings is intended to be illustrative rather than limiting, and any naming is used merely for distinguishing purpose without any meaning of limitation.

The principles and spirit of the present invention will be described in details below, with reference to a number of representative embodiments of the invention.

### Briefing of the Invention

The inventors have found that game applications applied on mobile terminals mostly employ a horizontal display manner of a display screen, wherein the vertical length on the horizontally displaying display screen is less than the horizontal length; thus it can be seen that when the horizontally displaying display screen is used to display game objects, the vertical length is a bigger concern as to the available space for displaying game objects. When display areas are set as taught in the prior art, since all of the display areas are set along the horizontal direction and separated from one another in the vertical direction on the display screen, each display area gets to occupy only a portion of the vertical length of the display screen, causing the vertical length of each of the display areas being too short, so that the game objects displayed in respective display areas would be too small due to the limitation of the vertical lengths of the display areas. Hence, regarding some game objects having specific content, it is difficult for a user to recognize the specific content on the displayed game objects, causing difficult in clearly displaying the specific content on the game objects. It can thus be seen that, in order to display the specific content on the game objects clearly, it is necessary to prevent all of the display areas from sharing the display screen in the above manner, and in particular, to prevent all of the display areas from being separated from (i.e., stacked on top of) one another in the vertical direction on the display screen.

Based on the above analysis, the basic idea of the present invention is as follows: setting a first display area and a second display area on a horizontally displaying display screen such that the first display area and the second display area are separated from one another along the horizontal direction on the display screen, wherein, the first display area alone occupies a vertical edge on one side of the display screen, and its vertical length is the entire vertical length on the display screen; the second display area is set along the horizontal direction in a remaining area on the display screen outside of the first display area, and its horizontal length is the horizontal length of the remaining area. Hence, on the one hand, the first display area and the second display area are separated from one another in the horizontal direction, so that the two no longer simultaneously share the vertical length of the display screen. Therefore, the vertical lengths of the first display area and the second display area are both extended so that game objects displayed in both of the display areas would not be too small, and the user can more easily recognize specific content on the game objects, thereby achieving clearer display of the specific content on the game objects. On the other hand, although the first display area and the second display area are separated from one another in the horizontal direction such that they simultaneously share the horizontal length of the display screen, since the horizontally displaying display screen has a longer horizontal side, there will not cause limitation to the game objects in the horizontal dimension, and therefore the game objects will not become smaller.

Having presented the basic principles of the present invention, various non-limiting embodiments of the invention will be described below with particularity.

### Overview of Application Scenarios

First, refer to FIG. 2, which is a framework diagram of an exemplary application scenario of the embodiments of the invention. Wherein, a user interacts with a server 201, said server providing game application services through a client 202 installed on a user equipment. It is understood by those skilled in the art that the framework diagram as shown in FIG. 2 is only one example in which the embodiments of the invention can be implemented. The applicable scope of the embodiments of the invention is not limited by this framework in any respect. For example, in another exemplary application scenario, the game application service may also be provided by the client 202 itself, and the user may interact only with the client 202 installed on the user equipment.

It should be noted that the user equipment herein may be any user equipment that is currently available, under developing, or developed in the future, and is capable of achieving interaction between the client 202 thereon and the server 201 through any form of wired and/or wireless connection (e.g., Wi-Fi, LAN, cell network, coaxial cable, etc.), including but not limited to: a smartphone, a feature phone, a tablet computer, a laptop PC, a desktop PC, a small computer, a medium computer, a mainframe computer, etc. that is currently available, under development, or developed in the future.

It should also be noted that the server 201 herein is only an example of devices capable of providing game service to a user, which are currently available, under developing, or developed in the future. There is no limitation to the embodiments of the invention in this respect.

Based on the framework shown in FIG. 2, the client 202 may set a first display area along a first vertical edge of a horizontally displaying display screen so as to display first game objects in the first display area; the client 202 may set a second display area along the horizontal direction at a location on the display screen outside of the first display area so as to display second game objects in the second display area; wherein, a first vertical boundary of the first display area is the first vertical edge of the display screen, a first vertical boundary of the second display area is a second vertical edge of the display screen, and a second vertical boundary of the second display area overlaps with a second vertical boundary of the first display area.

It may be appreciated that, in the application scenario of the present invention, although actions of the embodiments of the invention are described as being executed by the client 202 herein and hereinafter, those actions may be partly executed by the client 202, partly executed by the server 201, or completely executed by the server 201. The present invention is not limited in respect of the executing subject so long as the actions disclosed by the embodiments of the present invention are executed.

### Exemplary Methods

A method for displaying game objects according to the exemplary embodiments of the present invention will be described below with reference to FIGS. 3-5, in connection with the application scenario of FIG. 2. It should be noted that the above application scenario is shown merely to facilitate the understanding of the spirit and principles of the invention, and there is no limitation to the embodiments of the invention in this respect. On the contrary, the embodiments of the invention may be applicable to any suitable scenario.

Referring to FIG. 3, there is shown a flow diagram of an example of the method for displaying game objects of the invention. In this example, the method may for example specifically comprise the following steps:

Step 301: setting a first display area along a first vertical edge of a horizontally displaying display screen so as to display first game objects in the first display area;

Step 302: outside of the first display area, setting a second display area along the horizontal direction of the display screen so as to display second game objects in the second display area;

wherein, a first vertical boundary of the first display area is the first vertical edge of the display screen, a first vertical boundary of the second display area is a second vertical edge of the display screen, and a second vertical boundary of the second display area overlaps (in part or totally) with a second vertical boundary of the first display area.

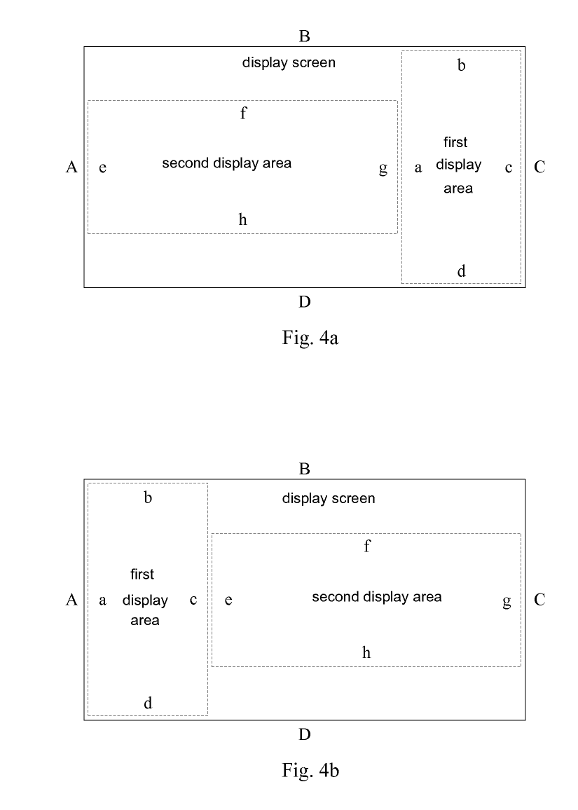

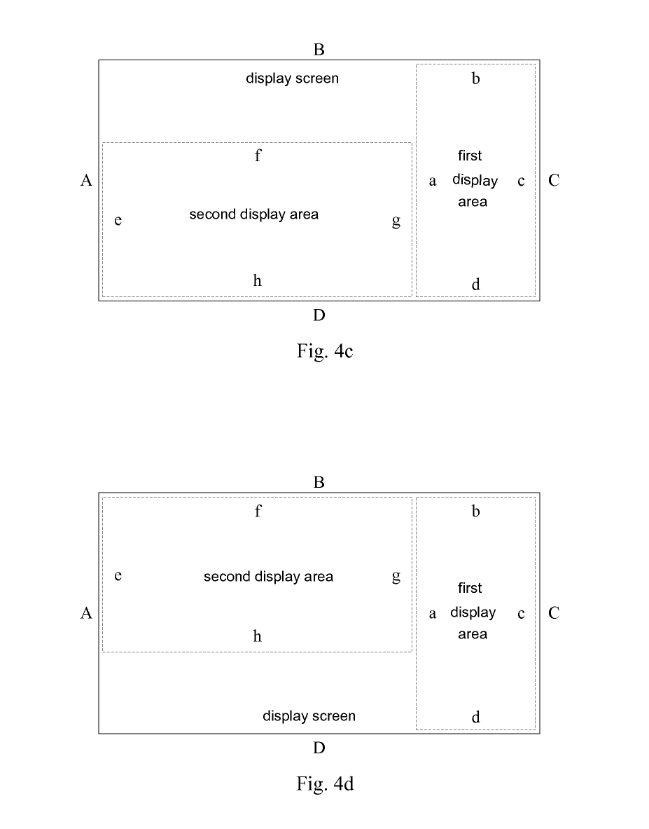

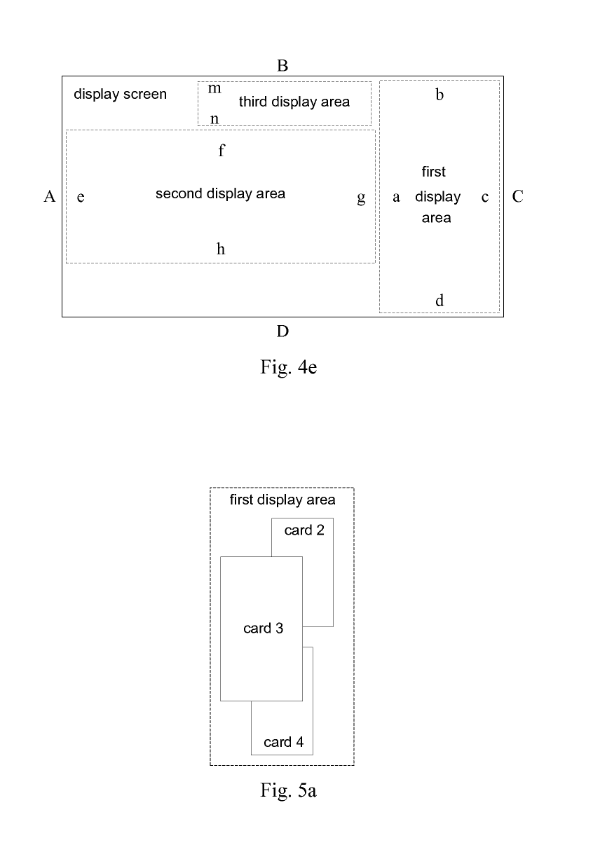

In order to more clearly show the way of setting the first display area and the second display area on the display screen, referring to FIG. 4, several examples of setting display areas on the display screen are listed. In those examples, two vertical edges of the display screen are respectively A and C, and two horizontal edges thereof are respectively B and D; two vertical boundaries of the first display area are respectively a and c, and two horizontal boundaries thereof are respectively b and d; two vertical boundaries of the second display area are respectively e and g, and two horizontal boundaries thereof respectively are f and h. Wherein, the first display area is set along one vertical edge (A or C) of the display screen; the two horizontal boundaries b and d of the first display area are respectively located on the two horizontal edges B and D of the display screen.

Referring to FIGS. 4a and 4b, in some embodiments of this example, the first game objects in the first display area may serve as objects provided to the user for operation. Further, the first game objects may be provided to the user for right hand operation, alternatively, the first game objects may also be provided to the user for left hand operation.

For example, FIG. 4a shows an example of the way of setting the display areas, which facilitates the user operating the first game objects with the right hand. In this example, the first vertical edge of the display screen is C, and the first vertical boundary of the first display area is c, i.e., the first vertical boundary c of the first display area is (or in other words, of the same length as) the first vertical edge C of the display screen; the second vertical edge of the display screen is A, and the first vertical boundary of the second display area is e, i.e., the first vertical boundary e of the second display area is of same length as the second vertical edge A of the display screen, or a portion thereof; the second vertical boundary of the first display area is a, and the second vertical boundary of the second display area is g, i.e., the second vertical boundary a of the first display area at least partially overlaps with (or in other words, is in immediate close proximity to) the second vertical boundary g of the second display area. In this example, the first display area is set along the right edge of the display screen, so that it may facilitate the user operating the first game objects in the first display area with the right hand.

For another example, FIG. 4b shows an example of the way of setting the display areas, which facilitates the user operating the first game objects with the left hand. In this example, the first vertical edge of the display screen is A, and the first vertical boundary of the first display area is a, i.e., the first vertical boundary a of the first display area is the first vertical edge A of the display screen; the second vertical edge of the display screen is C, and the first vertical boundary of the second display area is g, i.e., the first vertical boundary g of the second display area is of the same length as the second vertical edge C of the display screen, or a portion thereof; the second vertical boundary of the first display area is c, and the second vertical boundary of the second display area is e, i.e., the second vertical boundary c of the first display area at least partially overlaps with (or in other words, is in immediate close proximity to) the second vertical boundary e of the second display area. In this example, the first display area is set along the left edge of the display screen, so that it may facilitate the user operating the first game objects in the first display area with the left hand.

Referring to FIGS. 4a, 4c and 4d, in some other embodiments of this example, the vertical length and location of the second display area may be adaptively adjusted, taking into consideration of the vertical length that needs to be occupied for displaying game objects in the second display area and the vertical length that needs to be occupied by other game objects displayed outside of the first display area and the second display area.

For example, in the example of setting display areas as shown in FIG. 4a, the second display area is located at a middle position of the display screen in the vertical direction; specifically, neither of the two horizontal boundaries f and h of the second display area is located at the two horizontal edges B and D of the display screen, instead, a certain vertical distance is kept between the horizontal boundary f of the second display area and the horizontal edge B of the display screen, and a certain vertical distance is also kept between the horizontal boundary h of the second display area and the horizontal edge D of the display screen, so that certain areas capable of displaying other game objects are left outside of the second display area on the display screen.

For another example, in the examples of setting display areas as shown in FIGS. 4c and 4d, a horizontal boundary of the second display area is located at a horizontal edge of the display screen, and the other horizontal boundary thereof is not located at the other horizontal edge of the display screen. Specifically, in the example shown in FIG. 4c, the horizontal boundary h of the second display area is located at or in close proximity to the horizontal edge D of the display screen, and a certain vertical distance is kept between the horizontal boundary f of the second display area and the horizontal edge B of the display screen; in the example shown in FIG. 4d, the horizontal boundary f of the second display area is located at or in close proximity to the horizontal edge B of the display screen, and a certain vertical distance is kept between the horizontal boundary h of the second display area and the horizontal edge D of the display screen. In this way, a certain area capable of displaying other game objects is left outside of the second display area on the display screen.

Of course, it may be appreciated that, in some embodiments, the second display area may also occupy the entire area on the display screen outside of the first display area, that is, the horizontal boundary h of the second display area is located at or in close proximity to the horizontal edge D of the display screen, and the horizontal boundary f of the second display area is located at or in close proximity to the horizontal edge B of the display screen.

Referring to FIG. 4e, in some embodiments of the present example, in addition to the first display area and the second display area, a third display area for displaying third game objects may also be set on the display screen, taking into consideration of the need of setting a plurality of display areas on the display screen. Specifically, a horizontal boundary m of the third display area may be located at the horizontal edge B of the display screen, and a horizontal boundary n of the third display area may overlap or set in close proximity to with the horizontal boundary f of the second display area.

In an application scenario of the present example, the way of displaying the game objects in the present example may for example be applied to a battle game application. In the battle game application, an operating user and an opponent user may respectively operate their respective resource objects, and after the use of the resource objects, their respective battle objects participate in the battle. Specifically, the first game objects displayed in the first display area may for example be the operating user's resource objects, and the second game objects displayed in the second display area may for example be battle objects. Moreover, the opponent user's resource objects may for example be displayed in the third display area as the third game objects, and the third display area may for example be set as shown in FIG. 4e. It may be appreciated that, by placing and displaying the operating user's resource objects in the first display area located at the vertical edge of the display screen, operations such as selection and review of the operating user's resource objects by the operating user may be made simpler and easier.

More specifically, in a battle game application of a trade card game (abbreviated as TCG), the user's resource objects are mainly his/her cards representing characters/tools/facilities, and the battle objects participating in the battle are mainly various battle creatures on the field generated after the use of the cards. Hence, in the application scenario of the TCG, the first game objects may be the operating user's cards, and the second game objects may be creatures sent from both the operating and opponent users. Moreover, there is a correspondence relationship between the first game objects and the second game objects, i.e., the second game objects are generated after the selection of the first game objects. Specifically, second game objects are game objects to be presented after corresponding first game objects are moved into the second display area, and said corresponding first game objects will no longer be displayed in the first display area after the second game objects are presented. In other words, after a certain first game object is selected and put into use in the game, the first game object is no longer displayed in the first display area, and a corresponding second game object is displayed in the second display area.

It should be noted that, based on the foregoing description, one of the considerations for setting the first display area along a vertical edge of the horizontally displaying display screen in the present example is to facilitate the user to operate the first game objects displayed in the first display area. In the embodiments below, an implementation of the operation for the first game objects by the user is described.

In some embodiments of the present example, there are plenty of first game objects available for display, and it is difficult for the first display area to display all of the first game objects. By responding to a user's sliding operation within the first display area, wherein said sliding operation might be targeting at either a specific object or just any place in the first display area, it may choose which of the first game objects is to be displayed in the first display area. Such the sliding operation will enable all of the first game objects to be alternatively displayed in the first display area in a dynamic manner as the user desires. Specifically, the present example may further comprise: in response to a sliding operation of a contacting object (i.e., a user's finger) within the first display area, sliding each of the first game objects along a predetermined trajectory in the first display area accordingly, so as to change where said first game objects are displayed along the predetermined trajectory in the first display area.

More specifically, in response to the sliding operation of the user, the sliding trajectory of the first game objects may be accordingly determined. For example, in some embodiments, it comprise: (1) in response to the sliding operation within the first display area, determining the direction and length of the sliding trajectory of the sliding operation; (2) determining a sliding direction and sliding distance of each of the first game objects along the predetermined trajectory according to the direction and length of the sliding trajectory; and (3) sliding each of the first game objects to a respective display position on the predetermined trajectory for displaying according to said determined sliding direction and sliding distance. Further, in the above step (2), in one implementation, the vertical component of the first game object's sliding along the predetermined trajectory is same or proportional to the vertical component of the user's sliding direction, and the actual sliding distance of the first game objects along the predetermined trajectory is also proportional to the user's sliding distance. Moreover, for each of the first game objects available for display, if the stop end of the sliding trajectory of a first game object is within the first display area, the first game object may be displayed at a corresponding position of the first display area; while if the stop end of the sliding trajectory of the first game object is not within the first display area, the first game object may not be displayed in the first display area.

It may be appreciated that when the first game objects are displayed on the predetermined trajectory, the predetermined trajectory may provide one or more positions in the first display area to display said first game object respectively. Furthermore, in order to present the first game objects as many as possible all at once on the premise that the specific contents on the first game objects are clearly presented, the positions provided by the predetermined trajectory in the first display area may include a primary display position and a secondary display position, and the first game objects at the primary display position may be placed and presented in front of the first game objects at the secondary display position to ensure that the specific content on the first game objects at the primary display position can be clearly and completely presented to the user. Specifically, in some embodiments, in the overlapping parts of the first game objects displayed at the primary display position and the first game objects displayed at the secondary display position, the primary display position will be displayed and thus block the secondary display position. As discussed earlier, the primary display position and the secondary display position may be provided on a predetermined trajectory. In one example, the primary display position may be located in the middle of the display area, and the secondary display position may be respectively located on both sides of the primary display position in the vertical direction. Further, information of the first game object displayed at the primary display position is displayed in a zoom-out status, information of the first game object displayed at the secondary display position is displayed in a zoom-in status, and in an overlapped area between the first game object displayed at the primary display position and the first game object displayed at the secondary display position, only the first game object displayed at the primary display position is displayed. Thus, in response to a sliding operation within the first display area, said first game objects on the predetermined trajectory change not only display positions, but also display size.

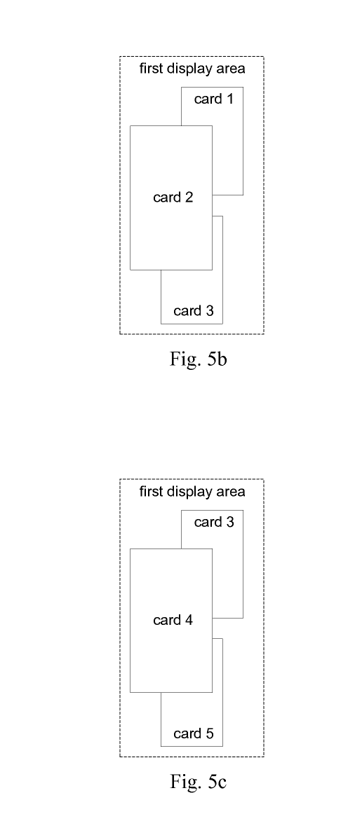

In an example of displaying the first game objects in the first display area as shown in FIG. 5a, the cards are regarded as the first game objects, the primary display position is the position of card 3, and the secondary display positions are positions of card 2 and card 4. When the user performs a downward sliding operation, and assuming that the sliding operation makes all cards to slide one display position along the trajectory, as shown in FIG. 5b, card 2 may slide from its previous top secondary display position to the middle primary display position, card 3 may slide from its middle primary display position to the bottom secondary display position, card 4 may slide from the bottom secondary display position to the outside of the first display area, and card 1 may slide from the outside of the first display area to the top secondary display position. When the user performs an upward sliding operation, and assuming that the sliding operation makes all cards to slide one display position along the trajectory, as shown in FIG. 5c, card 2 may slide from the top secondary display position to the outside of the first display area, card 3 may slide from the middle primary display position to the top secondary display position, card 4 may slide from the bottom secondary display position to the primary display position, and card 5 may slide from the outside of the first display area to the bottom secondary display position. It can thus be seen that, by way of such sliding operation, the cards may scroll in a trajectory like a “waterwheel”, and may also gradually become larger as they slide from the secondary display position to the primary display position, or gradually become smaller as they slide from the primary display position to the secondary display position, thereby providing 3D visual effect and more efficient use of display space in the process of selecting and displaying the cards. In one embodiment, said predetermined trajectory is a closed loop so as enable said first game objects to slide along the predetermined trajectory cyclically. In another embodiment, said predetermined trajectory is an open ended curve within said first display area, and said first game objects slide at most to the end points of the predetermined trajectory. In yet another embodiment, unlike FIG. 5a-5c, said first game objects will not disappear from the first display area, i.e., will not be moved out of the first display area by said sliding operation.

In some other embodiments of the present example, it provides a moving operation of the first game objects by user dragging the first game objects out of the first display area. In such a process, the first game objects may be moved following the trajectory of the user's moving operation. Specifically, the present example may for example further comprise: in response to the moving operation for the first game objects, taking a selected first game object as a current moving object, and displaying the moving process of the current moving object according to the movement trajectory of the moving operation. Typically, one of the first game objects in the first display areas which is being touched by a user's finger is taken as a current moving object. While the current moving object is being touched and dragged by the finger, the moving process of the current moving object is presented following the finger's movement trajectory, and in response to the current moving object being released from finger's touch, said moving operation stops.

More specifically, in order to use said first game objects, by the moving operation for the first game objects by the user, the display of the first game objects may for example specifically comprise: taking a first game object displayed at the starting position of the movement trajectory of the moving operation as a current moving object, and moving the display position of the current moving object along the movement trajectory; in response to the stopping of the moving operation for the current moving object, deciding whether an end position of the movement trajectory where the current moving object stops is outside of the first display area, if so, performing a corresponding action of the current moving object at the end position. Regarding the visual effect, when the user drags a first game object, i.e., when he/she performs a moving operation of the first game object, the first game object is displayed at the starting position of the movement trajectory, it looks as if the first game object is adhered to a contacting object (e.g., a finger of the user); as the contacting object moves on the display screen, the first game object is displayed following the track of the contacting object; when the user stops dragging and releases the first game object, i.e., at the moment when the contacting object leaves the display screen, the position where the first game object is currently located is the end position of the movement trajectory; if the end position leaves the first display area, it means certain resources represented by said first game object is going to be used in the game, and the predetermined action of the first game object will be performed. For example, after a moving operation, when the first game object has already left the first display area, the second game object corresponding to the first game object is generated and displayed in the second display area. Of course, more specifically, it is also possible to display the second game object only after the first game object has already entered into the second display area. Moreover, if the first game object is still located in the first display area after the moving operation because the end position of the movement trajectory does not leave the first display area, the first game object, for example, may return to the position where it was located before the moving operation, i.e., the first game object is displayed again at the starting position of the movement trajectory. Through various embodiments of moving operation, the user may drag a card of the first display area into the second display area in the TCG game application so as to complete the operation of using the card, then, the second display area displays an on-the-field creature corresponding to the card to participate the battle.

As compared with display areas in the prior art, through the technical solution of the present example, the vertical length of the first display area is extended to the vertical length of the entire display screen. Further, the first display area no longer shares the vertical length of the display screen with the second display area so that the vertical lengths of the first display area and the second display area are both extended. As such, the first game objects and the second game objects displayed in this way would not be excessively small. It is easier for a user to recognize specific content on the game objects, thereby achieving clearer display of the specific content on the game objects and bringing about a better experience for the user.

### Exemplary Device

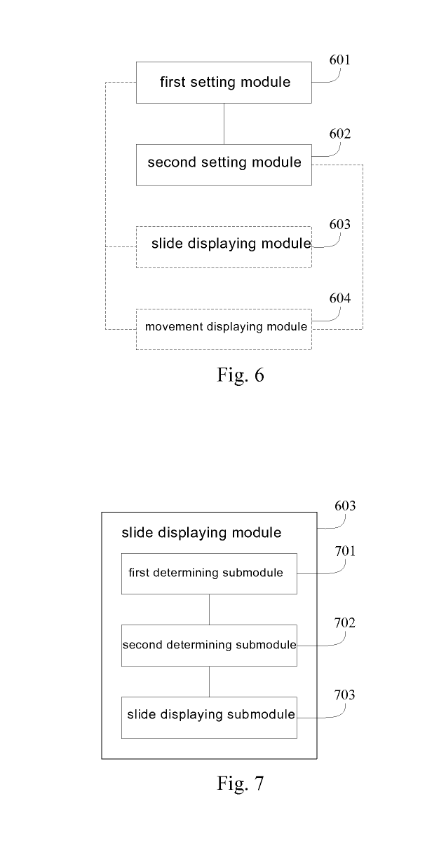

Having presented the method of the exemplary embodiments of the invention, a device for displaying game objects of the exemplary embodiments of the invention will then be described with reference to FIGS. 6-8.

Referring to FIG. 6, there is illustrated a structure diagram of an example of the device for displaying game objects of the invention. In this example, the device may be a handheld device with a touch-interaction display, said display screen being capable of horizontally displaying a game scene. Said device for example specifically comprise:

a first setting module 601 used for setting a first display area along a first vertical edge of the display screen so as to display at least a first game object in the first display area, said first display area being a first functional zone of the game;

a second setting module 602 used for, outside of the first display area, setting a second display area along the horizontal direction of the display screen so as to display at least a second game object in the second display area, said second display area being a second functional zone of the game;

wherein, a first vertical boundary of the first display area is the first vertical edge of the display screen, a first vertical boundary of the second display area is a second vertical edge of the display screen, and a second vertical boundary of the second display area at least partially overlaps with or in close proximity to a second vertical boundary of the first display area.

In some embodiments of the present example, the first setting module further sets a predetermined trajectory in the first display area and provides at least a display position on said predetermined trajectory to display said at least one first game object respectively. Said display positions on said predetermined trajectory comprising: a primary display position, and at least a secondary display position, wherein information of the first game object displayed at the primary display position is displayed in a zoom-out status, information of the first game object displayed at the secondary display position is displayed in a zoom-in status, and in an overlapped area between the first game object displayed at the primary display position and the first game object displayed at the secondary display position, only the first game object displayed at the primary display position is displayed. The device may for example further comprise:

a slide displaying module 603 for, in response to a sliding operation of a contacting object within the first display area, sliding said first game objects on the predetermined trajectory to change the display status of said first game objects.

Furthermore, in some embodiments, as shown in FIG. 7, the slide displaying module 603 may for example specifically comprise:

a first determining submodule 701 for, in response to the sliding operation within the first display area, determining the direction and length of the sliding trajectory of the sliding operation;

a second determining submodule 702 for determining a sliding trajectory of each of the first game objects available for display along the predetermined trajectory, according to the direction and length of the sliding trajectory of the sliding operation as determined by submodule 701;

a slide displaying submodule 703 for based on the sliding trajectory as determined by submodule 702, sliding first game objects available for display to respective positions of the predetermined trajectory for displaying.

Furthermore, in some other embodiments, positions provided by the predetermined trajectory in the first display area and used to display the first game objects may for example specifically comprise a primary display position and a secondary display position, wherein, information of the first game object displayed at the primary display position is displayed in a zoom-out status, information of the first game object displayed at the secondary display position is displayed in a zoom-in status, and in an overlapped area between the first game object displayed at the primary display position and the first game object displayed at the secondary display position, only the first game object displayed at the primary display position is displayed.

In some other embodiments of the present example, the device may for example further comprise:

a movement displaying module 604 for, in response to the moving operation for the first game objects, taking a selected first game object as a current moving object, and displaying the moving process of the current moving object according to the movement trajectory of the moving operation. More specifically, in response to a moving operation for moving a first game object out of said first display area, said module 604 takes one of the first game objects in the first display areas which is being touched as a current moving object, while the current moving object is being touched and moved, displays the moving process of the current moving object according to the movement trajectory of the moving operation. In response to the current moving object being released from said touch, said operation stops.

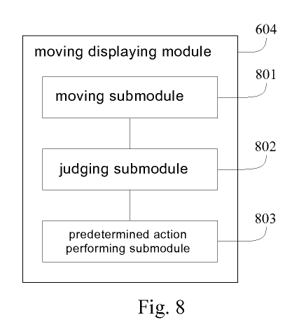

Furthermore, in some embodiments, as shown in FIG. 8, the movement displaying module 604 may for example specifically comprise:

a moving submodule 801 used for, taking a first game object displayed at the starting position of the movement trajectory of the moving operation as a current moving object, and moving the display position of the current moving object along the movement trajectory;

a judging submodule 802 used for, in response to the stopping of the moving operation for the current moving object, judging whether a stop end of the movement trajectory where the current moving object is currently located is outside of the first display area;

a predetermined action performing submodule 803, used for, if a decision of the judging means is yes, performing a corresponding action of the current moving object at the stop end.

In some other embodiments of the present example, the device may for example be specifically applied to battle game applications, wherein, the second game objects may be game objects being presented after the first game objects have been moved into the second display area; and wherein the first game objects are no longer displayed in the first display area after the second game objects are presented.

With the embodiments of the exemplary device provided by the invention, the vertical length of the first display area is extended to the vertical length of the entire display screen, and the first display area no longer shares the vertical length of the display screen with the second display area so that the vertical lengths of the first display area and the second display area are both extended. As such, the first game objects and the second game objects displayed in this way would not be excessively small so that it is easier for a user to recognize specific content on the game objects, thereby achieving clearer display of the specific content on the game objects and bringing about a better experience for the user.

It should be noted that, although a number of modules or sub-modules of the device for displaying game objects have been set forth in the above detailed description, such division is non-mandatory. In fact, the features and functionalities of two or more of the modules described above may be embodied in a single device, in accordance with the embodiments of the invention. Conversely, the features and functionalities of a single device describe above may be further divided to be embodied by a plurality of devices.

Moreover, although the operations of the method of the present invention have been described in a specific order/sequence in the drawings, this does not require or imply that those operations are necessarily performed in such specific order, or that all of the illustrated operations have to be performed to achieve desired results. Additionally or alternatively, certain steps may be omitted, a plurality of steps may be combined and performed in a single step, and/or a single step may be broken up into and performed in a plurality of steps.

Although the spirit and principles of the present invention have been described with reference to a number of specific embodiments, it should be understood that the present invention is not limited to the disclosed specific embodiments, and the division of various aspects does not mean that features in those aspects cannot be combined to benefit, and such division is merely for the convenience of presentation. The present invention is intended to cover various modifications and equivalent arrangements within the spirit and scope of the appended claims.

What is claimed is:

1. A display method used in a handheld device with a touch-interaction display screen, said display screen being capable of horizontally displaying a game scene, comprising:
setting a first display area along a first vertical edge of the display screen so as to display at least a first game object in the first display area, said first display area being a first functional zone of the game; and
outside of the first display area, setting a second display area along the horizontal direction of the display screen so as to display at least a second game object in the second display area, said second display area being a second functional zone of the game;
wherein, a first vertical boundary of the first display area is the first vertical edge of the display screen, a first vertical boundary of the second display area is a second vertical edge of the display screen, and a second vertical boundary of the second display area at least partially overlaps with or in close proximity to a second vertical boundary of the first display area.

2. The method of claim 1, further comprising:
setting a predetermined trajectory in the first display area and providing at least a display position on said predetermined trajectory to display said at least one first game object respectively.

3. The method of claim 2, wherein said display positions on said predetermined trajectory comprise:
a primary display position, and
at least a secondary display position,
wherein information of the first game object displayed at the primary display position is displayed in a zoom-out status, information of the first game object displayed at the secondary display position is displayed in a zoom-in status, and
in an overlapped area between the first game object displayed at the primary display position and the first game object displayed at the secondary display position, only the first game object displayed at the primary display position is displayed.

4. The method of claim 2, further comprising:
in response to a sliding operation of a contacting object within the first display area, sliding said first game objects on the predetermined trajectory to change the display status of said first game objects.

5. The method of claim 4, wherein said sliding said first game objects on the predetermined trajectory in response to a sliding operation within the first display area comprises:
in response to the sliding operation within the first display area, determining the direction and length of the sliding trajectory of the sliding operation;
determining a sliding direction and sliding distance of each of the first game objects along the predetermined trajectory according to the direction and length of the sliding trajectory; and
sliding each of the first game objects to a respective display position on the predetermined trajectory for displaying according to said determined sliding direction and sliding distance.

6. The method of claim 2, wherein said predetermined trajectory is a closed loop within said first display area so as enable said first game objects to slide along the predetermined trajectory cyclically.

7. The method of claim 2, wherein said predetermined trajectory is an open ended curve within said first display area, and said first game objects slide at most to the end points of the predetermined trajectory.

8. The method of claim 1, further comprising, in response to a moving operation for moving a first game object out of said first display area:
taking one of the first game objects in the first display areas which is being touched as a current moving object,
while the current moving object is being touched and moved, displaying the moving process of the current moving object according to the movement trajectory of the moving operation; and
in response to the current moving object being released from said touch, said moving operation stops.

9. The method of claim 8, further comprising:
taking a first game object displayed at the starting position of the movement trajectory of the moving operation as a current moving object, and moving the display position of the current moving object along the movement trajectory; and
in response to the stopping of the moving operation for the current moving object, deciding whether a stop end of the movement trajectory where the current moving object is currently located is outside of the first display area, if yes, performing a corresponding action of the current moving object at the stop end.

10. The method of claim 1, wherein said method is applied to display a battle game application, and,
in the first functional zone, the first game objects displayed in the first display area are resource objects of the handheld device's user, and in the second functional zone, the second game objects displayed in the second display area are battle objects of the handheld device's user, and
the second game objects are game objects being presented after the first game objects have been moved out of the first display area and into the second display area.

11. A handheld device with a touch-interaction display, said display screen being capable of horizontally displaying a game scene, said device comprises:
a first setting module configured for setting a first display area along a first vertical edge of the display screen so as to display at least a first game object in the first display area, said first display area being a first functional zone of the game; and
a second setting module configured for, outside of the first display area, setting a second display area along the horizontal direction of the display screen so as to display at least a second game object in the second display area, said second display area being a second functional zone of the game;
wherein, a first vertical boundary of the first display area is the first vertical edge of the display screen, a first vertical boundary of the second display area is a second vertical edge of the display screen, and a second vertical boundary of the second display area at least partially overlaps with or in close proximity to a second vertical boundary of the first display area.

12. The device of claim 11, wherein the first setting module is further configured to set a predetermined trajectory in the first display area and provide at least a display position on said predetermined trajectory to display said at least one first game object respectively.

13. The device of claim 12, said display positions on said predetermined trajectory comprises:
a primary display position, and
at least a secondary display position,
wherein information of the first game object displayed at the primary display position is displayed in a zoom-out status, information of the first game object displayed at the secondary display position is displayed in a zoom-in status, and
in an overlapped area between the first game object displayed at the primary display position and the first game object displayed at the secondary display position, only the first game object displayed at the primary display position is displayed.

14. The device of claim 12, further comprising a slide displaying module, which is configured for, in response to a sliding operation of a contacting object within the first display area, sliding said first game objects on the predetermined trajectory to change the display status of said first game objects.

15. The device of claim 14, said slide displaying module further comprises:
a first determining submodule configured for, in response to the sliding operation within the first display area, determining the direction and length of the sliding trajectory of the sliding operation;
a second determining submodule configured for, determining a sliding direction and sliding distance of each of the first game objects along the predetermined trajectory the direction and length of the sliding trajectory; and
slide displaying submodule configured for, based on said determined sliding direction and sliding distance, sliding each of the first game objects to a respective display position on the predetermined trajectory for displaying.

16. The device of claim 12, wherein said predetermined trajectory is a closed loop within said first display area so as enable said first game objects to slide along the predetermined trajectory cyclically.

17. The device of claim 12, wherein said predetermined trajectory is an open ended curve within said first display area, and said first game objects slide at most to the end points of the predetermined trajectory.

18. The device of claim 11, further comprising a movement displaying module, said movement displaying module is configured for:
in response to a moving operation for moving a first game object out of said first display area, taking one of the first game objects in the first display areas which is being touched as a current moving object, while the current moving object is being touched and moved, displaying the moving process of the current moving object according to the movement trajectory of the moving operation, and in response to the current moving object being released from said touch, said moving operation stops.

19. The device of claim 18, said movement displaying module further comprises:
moving submodule, configured for taking a first game object displayed at the starting position of the movement trajectory of the moving operation as a current moving object, and moving the display position of the current moving object along the movement trajectory; and
judging submodule configured for, in response to the stopping of the moving operation for the current moving object, deciding whether a stop end of the movement trajectory where the current moving object is currently located is outside of the first display area,
predetermined action performing submodule configured for, if a decision of the judging submodule is yes, performing a corresponding action of the current moving object at the stop end.

20. The device of claim 11, wherein said handheld device is used to display a battle game application, wherein,
in the first functional zone, the first game objects displayed in the first display area are resource objects of the handheld device's user, and in the second functional zone, the second game objects displayed in the second display area are battle objects of the handheld device's user, and
the second game objects are game objects being presented after the first game objects have been moved out of the first display area and into the second display area.
